(19) United States
(12) Patent Application Publication
(10) Pub. No.: US 2026/0171922 A1
(43) Pub. Date: Jun. 18, 2026

(54) AC TO AC MODIFIED SINE WAVE CONVERTER

(71) Applicant: Dongguan Fukun Electrical Appliance Co., Ltd., Dongguan City (CN)

(72) Inventor: Zhaokun Zeng, Dongguan City (CN)

(21) Appl. No.: 19/021,176

(22) Filed: Jan. 15, 2025

(30) Foreign Application Priority Data
Dec. 17, 2024 (CN) 2024231256155

(51) Int. Cl. H02M 5/458; H02J 7/06; H02M 1/00; H02M 1/088

(52) U.S. Cl. CPC H02M 5/458; H02J 7/06; H02M 1/0009; H02M 1/088; H02J 2207/20; H02J 2207/30

(57) ABSTRACT

An AC to AC modified sine wave converter, comprising: an AC input module, a rectifier filter circuit, a BUCK step-down circuit, a modified sine wave inverter bridge circuit, an inverter bridge control circuit, an AC output module, and a USB charging control circuit, wherein the modified sine wave inverter bridge circuit includes MOSFET M2, MOSFET M3, MOSFET M4, MOSFET M5, an input voltage monitoring module, an output current detection module, a first driving module connecting MOSFET M2 to the inverter bridge control circuit, a second driving module connecting MOSFET M3 to the inverter bridge control circuit, a third driving module connecting MOSFET M4 to the inverter bridge control circuit, and a fourth driving module connecting MOSFET M5 to the inverter bridge control circuit, and an AC power supply circuit is arranged between the inverter bridge control circuit and the USB charging control circuit.

### FIELD OF THE INVENTION

The present invention relates to the technical field of socket converters, and more particularly to an AC TO AC modified sine wave converter.

### BACKGROUND OF THE INVENTION

With the development of globalization and the prevalence of international travel, more and more people travel abroad for business, tourism, or work. However, different countries adopt different socket and voltage standards, creating inconvenience when using electronic devices. Currently, common socket types in the market include Type A (US standard), Type C (EU standard), Type G (UK standard), and Type I (AU standard), with voltages usually divided into 110V and 220V. When using electronic devices across countries, if the plug is incompatible or the voltage is mismatched, not only can it render the device unable to charge or operate properly, but it may also lead to equipment damage or even safety hazards.

A multi-country socket converter is a portable power adapter designed to solve these non-unified plug standards. Through built-in multiple plugs and socket ports, the converter can accommodate a variety of different types of socket interfaces. It also features voltage conversion functions, transforming the local voltage into the standard voltage required by electronic devices, thus ensuring smooth power connection in different countries and protecting devices'safety. Existing multi-country socket converters are typically compact, portable, and multifunctional, making them suitable for international travelers, businesspeople, and enterprises in global supply chain management. Furthermore, with technological advancement, some converters have also added USB ports, fast charging capabilities, etc., to further enhance convenience and device compatibility.

For example, the Chinese Utility Model Patent with Authorization Announcement No. CN204966896 U discloses a multi-country plug converter that includes a converter seat with a plug distribution surface. Inside the converter seat are socket contacts and a retractable plug. The retractable plug can extend out of or retract into the converter seat from the plug distribution surface. The retractable plug includes a UK-standard plug with a ground pin, as well as either a US-standard plug or an AU-standard plug (both having ground pins). Moreover, the US-standard or AU-standard plug is integrally distributed between the ground pin and IN pin of the UK-standard plug. This design further reduces the space occupied by the overall installation distribution structure of the multi-country plug converter, making it more reasonable and compact. By utilizing the multi-country plug pin distribution more effectively, the overall size is reduced, making the entire multi-country plug smaller and easier to carry.

In view of this, the inventor proposes the following technical solution.

### SUMMARY OF THE INVENTION

The purpose of the present invention is to overcome the deficiencies of the prior art and provide an AC TO AC modified sine wave converter.

To solve the above technical problems, the present invention adopts the following technical solution: An AC TO AC modified sine wave converter, comprising: an AC input module, a rectifier filter circuit, a BUCK step-down circuit, a modified sine wave inverter bridge circuit, an inverter bridge control circuit, an AC output module, and a USB charging control circuit. The modified sine wave inverter bridge circuit includes MOSFET M2, MOSFET M3, MOSFET M4, MOSFET M5, an input voltage monitoring module, an output current detection module, a first driving module connecting MOSFET M2 to the inverter bridge control circuit, a second driving module connecting MOSFET M3 to the inverter bridge control circuit, a third driving module connecting MOSFET M4 to the inverter bridge control circuit, and a fourth driving module connecting MOSFET M5 to the inverter bridge control circuit. An AC power supply circuit for the inverter bridge control circuit is provided between the inverter bridge control circuit and the USB charging control circuit.

Further, in the above technical solution, the first driving module includes a resistor R10 and a resistor R11 connected in series between the gate (G) of MOSFET M2 and the H01 pin of the inverter bridge control circuit, a diode D2 connected in parallel with resistor R10, and a resistor R14 connecting the gate (G) and source (S) of MOSFET M2. The second driving module, the third driving module, and the fourth driving module are all identical to the first driving module. Furthermore, the source(S) of MOSFET M2 is connected to the drain (D) of MOSFET M4 and then connected to the N-OUT pin of the AC output module, while the source(S) of MOSFET M3 and the drain (D) of MOSFET M5 are connected and then joined to the L-OUT pin of the AC output module.

Further, in the above technical solution, the input voltage monitoring module includes resistors R1, R4, and R5 connected in series between the VBUS pin of the inverter bridge control circuit and the BUCK step-down circuit, a capacitor C8 connected between the VBUS pin of the inverter bridge control circuit and resistor R1 and then to GND, a capacitor C9 and resistor R16 connected between resistor R1 and resistor R4 and then to GND, and a capacitor C46 connected between resistor R1 and the modified sine wave inverter bridge circuit and then to GND. The output current detection module includes resistors R31, R32, and R33 connected in parallel between the source (S) of MOSFET M4 and the source(S) of MOSFET M5.

Further, in the above technical solution, the AC power supply circuit includes MOSFET M8 and chip U9 connected in series between the USB charging control circuit and the inverter bridge control circuit, capacitors C39 and C40 respectively connected to the IN and OUT pins of chip U9, and capacitors C41 and C42 connected to the drain (D) and source(S) of MOSFET M8. The drain (D) of MOSFET M8 is connected to the VCC pin of the USB charging control circuit, and the gate (G) of MOSFET M8 is grounded together with capacitors C41 and C42. The source(S) of MOSFET M8 and the IN pin of chip U9 connect to the +12V pin, while the GND pin of chip U9 and capacitors C39 and C40 are grounded.

Further, in the above technical solution, the USB charging control circuit includes a fuse F3, a main control chip U6, a transformer T1, a power controller U3, a step-down converter U4, a first USB unit, a second USB unit, a third USB unit, and a fourth USB unit. Fuse F3 is connected to the BUCK step-down circuit, while the AC power supply circuit is connected to the VCC pin of the power controller U3. The first USB unit and the second USB unit are both Type-C output interfaces.

Further, in the above technical solution, the inverter bridge control circuit includes a chip IC1, an output temperature detection module, and a fan control module. The input voltage monitoring module is connected to the VBUS and GND pins of chip IC1. The first, second, third, and fourth driving modules are respectively connected to the H01, H02, LO1, and LO2 pins of chip IC1.

Further, in the above technical solution, the output temperature detection module includes a capacitor C19, resistor R35, resistor R38, resistor R78, and a diode LED1. Capacitor C19, resistor R35, and one end of resistor R38 are connected to the NTC pin of chip IC1. The other end of resistor R35 is connected to the AC-5V pin. Resistor R78 and diode LED1 are connected in series to the LED pin of chip IC1, while capacitor C19, resistor R38, and the other end of diode LED1 are grounded.

Further, in the above technical solution, the fan control module includes resistor R44, resistor R46, an optocoupler P1, resistor R47, resistor R48, MOSFET M7, and a fan F2. Resistor R44 and resistor R46 are connected in series to the FAN pin of chip IC1, with one end of resistor R46 grounded, and an optocoupler PAB is connected in parallel to resistor R46. The drain (D) of the MOSFET and the optocoupler P1A are respectively connected to both ends of fan F2. Resistor R47 is connected between the MOSFET gate (G) and optocoupler P1A, resistor R48 is connected between the MOSFET gate (G) and ground, and the source (S) of MOSFET M7 is grounded.

Further, in the above technical solution, the BUCK step-down circuit includes MOSFET M1, a fifth driving module, a current detection module, an energy storage filter module, a power control module, a power supply module, a freewheeling module, and an output voltage detection module. MOSFET M1 is connected to the rectifier filter circuit, the energy storage filter module is connected to the modified sine wave inverter bridge circuit, and an optocoupler P3 is arranged between the power control module and the output voltage detection module.

Further, in the above technical solution, the current detection module includes resistors R34, R36, and R45 connected in parallel to the source(S) of MOSFET M1. The other ends of resistors R34 and R36 are connected to the freewheeling module and the energy storage filter module, and the other end of resistor R45 is connected to the power control module.

Adopting the above technical solution, compared with the prior art, the present invention has the following beneficial effects: the BUCK step-down circuit (3) steps down a DC voltage of 150V-375V to a DC voltage of 120-150V. The full-bridge circuit composed of MOSFET M2, MOSFET M3, MOSFET M4, and MOSFET M5 converts DC into a modified sine wave AC output. A set of MOSFET M2 and MOSFET M5 is turned on simultaneously; the DC bus voltage flows from MOSFET M2 to the L terminal and returns from the N terminal through MOSFET M5 to the DC bus ground, forming a positive half-cycle voltage from L to N. Likewise, a set of MOSFET M3 and MOSFET M4 is turned on simultaneously; the DC bus voltage flows from MOSFET M4 to the N terminal and from the L terminal through MOSFET M3 back to the DC bus ground, forming a negative half-cycle voltage from N to L. Thus, an AC output is provided to the AC output module. In addition, the AC power supply circuit obtains power from the USB charging control circuit and provides power to the inverter bridge control circuit, eliminating the need for a dedicated power module for the inverter bridge control circuit.

### BRIEF DESCRIPTION OF THE DRAWINGS

FIG. 1 is a first circuit diagram of the present invention;

FIG. 2 is a second circuit diagram of the present invention;

FIG. 3 is a circuit diagram of the BUCK step-down circuit of the present invention;

FIG. 4 is a circuit diagram of the modified sine wave inverter bridge circuit of the present invention;

FIG. 5 is a circuit diagram of the output temperature detection module of the present invention;

FIG. 6 is a circuit diagram of the fan control module of the present invention;

FIG. 7 is a circuit diagram of the AC power supply circuit of the present invention.

### DETAILED DESCRIPTION OF THE EMBODIMENTS

Below, the present invention will be further described with reference to specific embodiments and the accompanying FIGS.

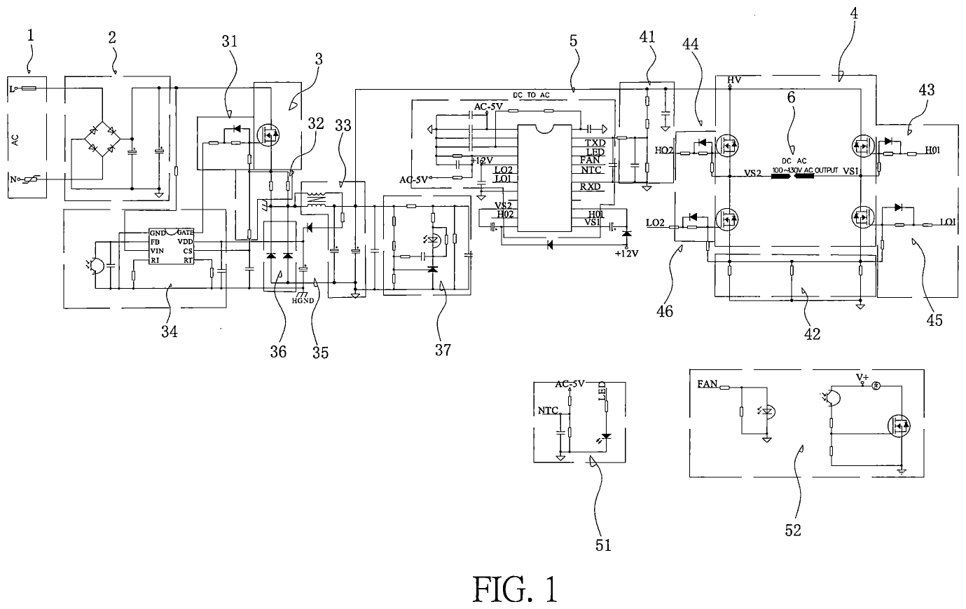

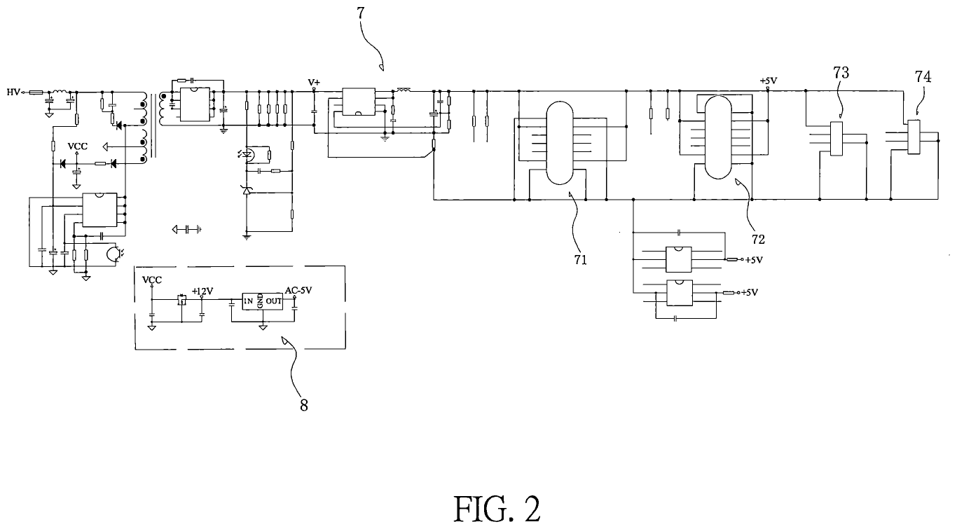

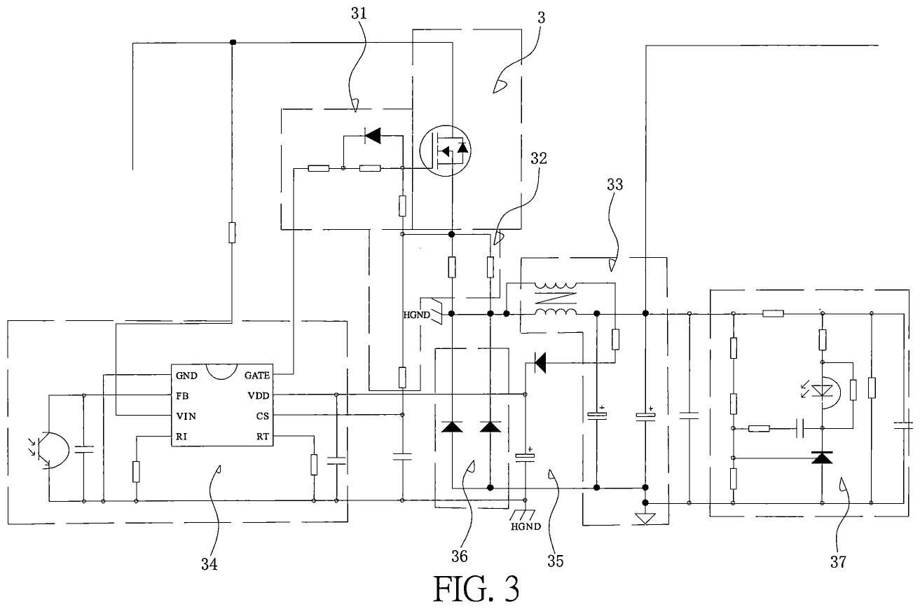

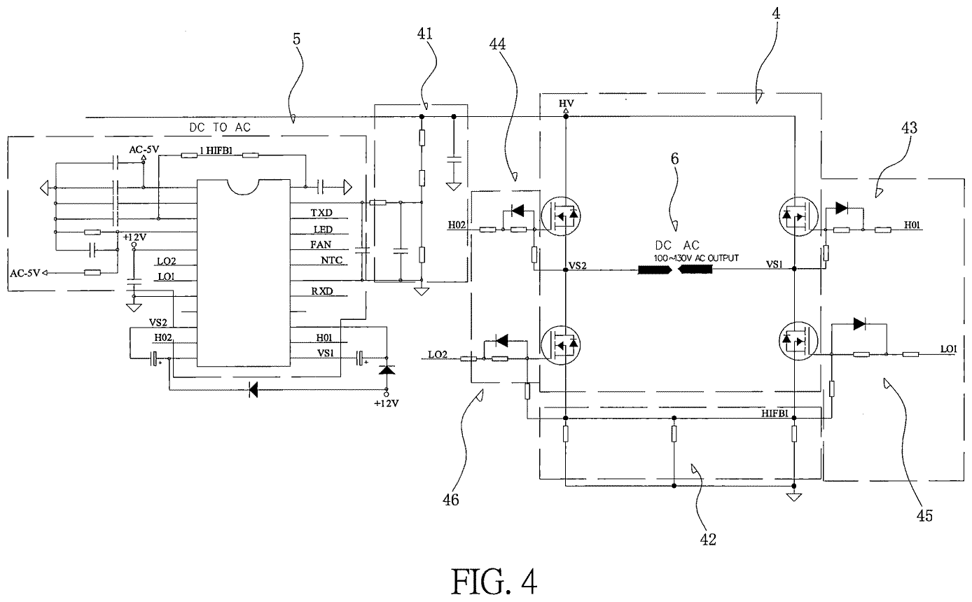

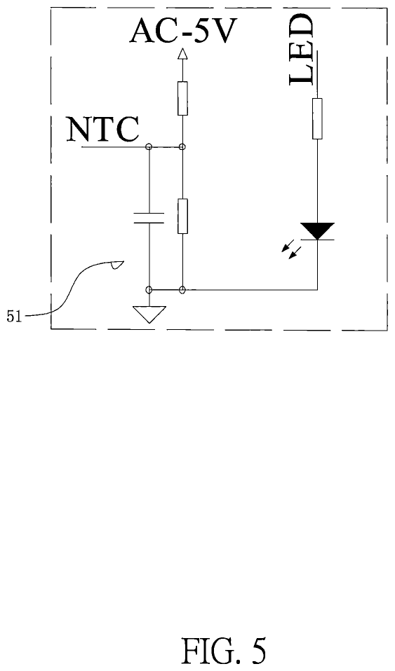

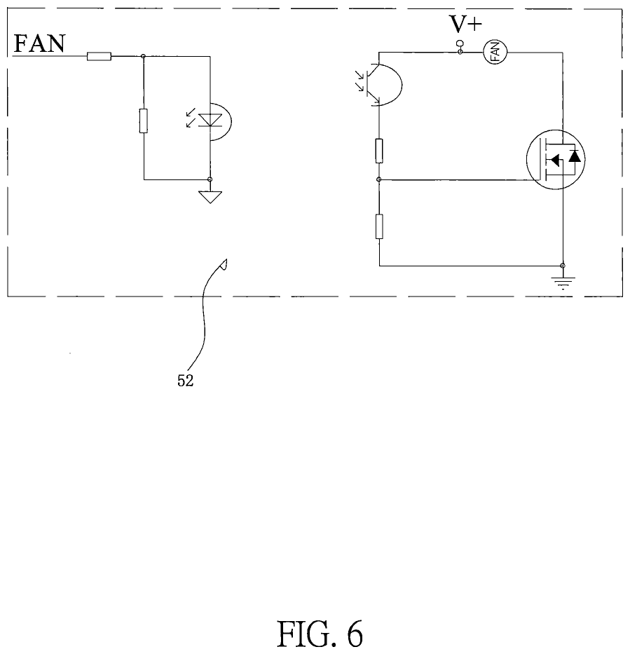

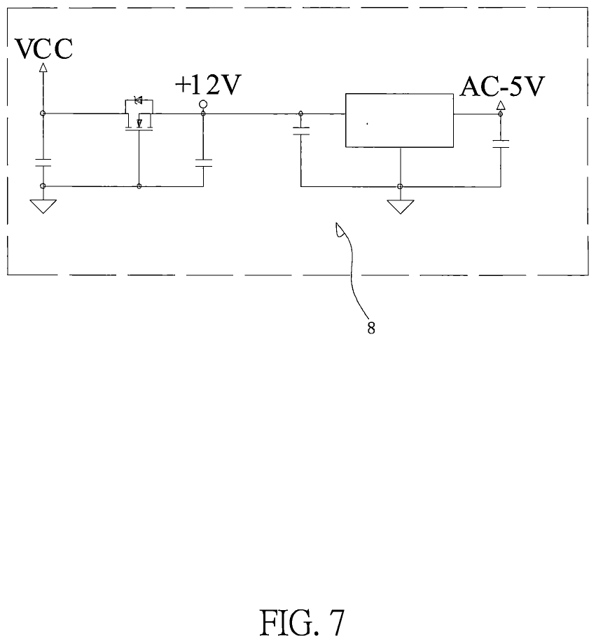

As shown in FIGS. 1 to 7, an AC TO AC modified sine wave converter includes: an AC input module (1), a rectifier filter circuit (2), a BUCK step-down circuit (3), a modified sine wave inverter bridge circuit (4), an inverter bridge control circuit (5), an AC output module (6), and a USB charging control circuit (7). The modified sine wave inverter bridge circuit (4) comprises MOSFET M2, MOSFET M3, MOSFET M4, MOSFET M5, an input voltage monitoring module (41), an output current detection module (42), a first driving module (43) that connects MOSFET M2 to the inverter bridge control circuit (5), a second driving module (44) that connects MOSFET M3 to the inverter bridge control circuit (5), a third driving module (45) that connects MOSFET M4 to the inverter bridge control circuit (5), and a fourth driving module (46) that connects MOSFET M5 to the inverter bridge control circuit (5). An AC power supply circuit (8) is provided between the inverter bridge control circuit (5) and the USB charging control circuit (7). The BUCK step-down circuit (3) steps down a DC voltage of 150V-375V to 120V-150V, and the full-bridge circuit composed of MOSFET M2, MOSFET M3, MOSFET M4, and MOSFET M5 converts the DC voltage into a modified sine wave AC output. MOSFET M2 and MOSFET M5 are switched on simultaneously, allowing the DC bus voltage to flow from MOSFET M2 to the L terminal and return from the N terminal through MOSFET M5 to the DC bus ground, forming a positive half-cycle voltage from L to N. Similarly, MOSFET M3 and MOSFET M4 are switched on simultaneously, allowing the DC bus voltage to flow from MOSFET M4 to the N terminal and return from the L terminal through MOSFET M3 to the DC bus ground, forming a negative half-cycle voltage from N to L. Thus, AC output module (6) outputs AC. In addition, AC power supply circuit (8) draws power from USB charging control circuit (7) for the inverter bridge control circuit (5), which does not require an independent power supply module.

The first driving module (43) includes resistors R10 and R11 connected in series between the gate (G) of MOSFET M2 and the H01 pin of the inverter bridge control circuit (5), a diode D2 connected in parallel with resistor R10, and a resistor R14 connecting the gate (G) and source(S) of MOSFET M2. The second driving module (44), the third driving module (45), and the fourth driving module (46) are identical to the first driving module (43). The source(S) of MOSFET M2 is connected to the drain (D) of MOSFET M4 and then to the N-OUT pin of AC output module (6). Meanwhile, the source(S) of MOSFET M3 and the drain (D) of MOSFET M5 are connected and then to the L-OUT pin of AC output module (6).

The input voltage monitoring module (41) includes resistors R1, R4, and R5 in series between the VBUS pin of inverter bridge control circuit (5) and BUCK step-down circuit (3), capacitor C8 connecting the VBUS pin of inverter bridge control circuit (5) and resistor R1 to GND, and capacitor C9 and resistor R16 connecting resistor R1 to resistor R4 to GND. Capacitor C46 is connected between resistor R1 and the modified sine wave inverter bridge circuit (4) to GND. The output current detection module (42) includes resistors R31, R32, and R33 connected in parallel between the sources (S) of MOSFET M4 and MOSFET M5. By detecting the input voltage through the input voltage monitoring module (41), duty cycle adjustments are made.

The AC power supply circuit (8) includes MOSFET M8 and chip U9 connected in series between the USB charging control circuit (7) and the inverter bridge control circuit (5), capacitors C39 and C40 respectively connected to the IN and OUT pins of chip U9, and capacitors C41 and C42 connected to the drain (D) and source(S) of MOSFET M8. The drain (D) of MOSFET M8 is connected to the VCC pin of USB charging control circuit (7). The gate (G) of MOSFET M8 is grounded together with capacitors C41 and C42. The source(S) of MOSFET M8 and the IN pin of chip U9 connect to the +12V pin. The GND pin of chip U9 and capacitors C39 and C40 are grounded.

The USB charging control circuit (7) includes fuse F3, main control chip U6, transformer T1, power controller U3, step-down converter U4, first USB unit (71), second USB unit (72), third USB unit (73), and fourth USB unit (74). Fuse F3 is connected to the BUCK step-down circuit (3). The AC power supply circuit (8) is connected to the VCC pin of power controller U3. The first USB unit (71) and the second USB unit (72) are Type-C output interfaces.

The inverter bridge control circuit (5) includes chip IC1, an output temperature detection module (51), and a fan control module (52). The input voltage monitoring module (41) is connected to the VBUS and GND pins of chip IC1. The first driving module (43), second driving module (44), third driving module (45), and fourth driving module (46) are respectively connected to the H01, H02, LO1, and LO2 pins of chip IC1.

The output temperature detection module (51) includes capacitor C19, resistor R35, resistor R38, resistor R78, and diode LED1. Capacitor C19, resistor R35, and one end of resistor R38 are connected to the NTC pin of chip IC1. The other end of resistor R35 is connected to the AC-5V pin. Resistor R78 and diode LED1 are connected in series to the LED pin of chip IC1, while capacitor C19, resistor R38, and the other end of diode LED1 are grounded.

The fan control module (52) includes resistor R44, resistor R46, optocoupler P1, resistor R47, resistor R48, MOSFET M7, and fan F2. Resistor R44 and resistor R46 are connected in series to the FAN pin of chip IC1, with one end of resistor R46 grounded. Optocoupler PAB is connected in parallel with resistor R46. The drain (D) of the MOSFET and the optocoupler P1A are respectively connected to both ends of fan F2. Resistor R47 is connected between the MOSFET gate (G) and optocoupler P1A. Resistor R48 is connected between the MOSFET gate (G) and ground. The source (S) of MOSFET M7 is grounded.

The BUCK step-down circuit (3) includes MOSFET M1, a fifth driving module (31), a current detection module (32), an energy storage filter module (33), a power control module (34), a power supply module (35), a freewheeling module (36), and an output voltage detection module (37). MOSFET M1 is connected to the rectifier filter circuit (2). The energy storage filter module (33) is connected to the modified sine wave inverter bridge circuit (4). An optocoupler P3 is arranged between the power control module (34) and the output voltage detection module (37).

The current detection module (32) includes resistors R34, R36, and R45 connected in parallel to the source(S) of MOSFET M1. The other ends of resistors R34 and R36 are connected to the freewheeling module (36) and the energy storage filter module (33), while the other end of resistor R45 is connected to the power control module (34). The freewheeling module (36) includes parallel diodes D7 and D13. One end of diodes D7 and D13 connects to the other ends of resistors R34 and R36, and the other end of diodes D7 and D13 is grounded.

The power control module (34) includes a PWM control chip U1. Resistor R45 is connected to the CS pin of PWM control chip U1. The fifth driving module (31) includes a diode D1 and resistor R7 connected in parallel to the gate (G) of MOSFET M1, as well as resistor R76 whose other end is connected to the source(S) of MOSFET M1. The other ends of diode D1 and resistor R7, after passing through resistor R6 in series, connect to the GATE pin of PWM control chip U1.

The energy storage filter module (33) includes an inductor L1, resistor R20, capacitor C14, and capacitor C17. Pins 3 and 4 of inductor L1 are connected to the current detection module (32). Resistor R20 is connected between pin 1 of inductor L1 and the power supply module (35). One end of capacitors C14 and C17 is connected in parallel to pin 2 of inductor L1, and the other end is grounded. Pin 2 of inductor L1 is also connected to the output voltage detection module (37) and the modified sine wave inverter bridge circuit (4). The power supply module (35) includes a diode D5 and a capacitor C13 connected in series. One end of diode D5 is connected to resistor R20 of the energy storage filter module (33), while the other end of diode D5 is connected to capacitor C13 and the VDD pin of PWM control chip U1. The other end of capacitor C13 is connected to pin 3 of inductor L1.

In summary, the working principle of the present invention is as follows:

During operation, the municipal AC power is input through the AC input module (1) after passing through the fuse and the NTC inrush current limiter, then rectified by the DB1 bridge stack and filtered by capacitors C6 and C7, becoming a smooth DC voltage.

Further, after passing through the BUCK step-down circuit (3) composed of MOSFET M1, inductor L1, resistors R34 and R36, diodes D7 and D13, and capacitor C14, the DC voltage in the range of 130V-375V is stepped down to 120V-150V.

Further, the BUCK step-down circuit (3) controls the on/off time of MOSFET M1 to send a pulse voltage into the filter network composed of inductor L1 and capacitor C14, forming a low-voltage and smooth DC output. Diodes D7 and D13 provide a freewheeling path for inductor L1, while resistors R34 and R36 serve as current-sensing resistors.

Furthermore, a voltage feedback loop consisting of resistor R18, resistor R25, resistor R30, optocoupler P3, and chip U2 sends feedback to chip U1 to regulate the voltage across capacitor C14, ensuring a stable bus voltage.

Moreover, inductor L1 has two mutually coupled windings. The primary winding is used for energy storage and filtering, while the secondary winding provides power to the control chip U1. The rectifier filter circuit composed of diode D5 and capacitor C13 supplies power to control chip U1 from the secondary winding of inductor L1.

Then, the full-bridge circuit composed of MOSFET M2, MOSFET M3, MOSFET M4, and MOSFET M6 converts the DC into a modified sine wave AC output. By simultaneously turning on MOSFET M3 and MOSFET M4, the DC bus voltage flows from MOSFET M3 to the L terminal and returns from the N terminal through MOSFET M4 to the DC bus ground, forming a positive half-cycle voltage from L to N. By simultaneously turning on MOSFET M2 and MOSFET M6, the DC bus voltage flows from MOSFET M2 to the N terminal and returns from the L terminal through MOSFET M6 to the DC bus ground, forming a negative half-cycle voltage from N to L.

Furthermore, by controlling the conduction time of MOSFET M2, MOSFET M3, MOSFET M4, and MOSFET M6, the AC output voltage is controlled.

In addition, resistors R31, R32, and R33 are current-sensing resistors for the DC-to-AC inverter section to regulate output current and protect against overcurrent or short-circuit conditions.

Additionally, resistors R1, R4, R5, and R16 form the bus input voltage detection and output voltage regulation circuit.

Inside chip IC1 is an integrated MCU control circuit and driver circuit, which drives the four MOSFET gates (M2, M3, M4, M6) via gate-series resistors, controlling MOSFET on/off switching.

Moreover, resistors R35 and R38 form a temperature detection circuit. Resistor R38 is an NTC thermistor whose resistance decreases with rising temperature, lowering the voltage sent to chip IC1. When the temperature reaches a certain level, chip IC1 outputs a high-level signal to activate optocoupler P1, turning on the cooling fan to dissipate heat. When the temperature exceeds a preset limit, chip IC1 shuts down its output.

Finally, MOSFET M8 draws power from the VCC end of USB charging control IC U6, converting it into 5V through chip U9 to supply the control circuit and internal MCU of chip IC1, while MOSFET M8 outputs 12V to power the internal driver circuit of chip IC1.

Of course, the above is merely a specific embodiment of the present invention and is not intended to limit the scope of its implementation. Any equivalent changes or modifications to the structure, features, and principles described in the claims of the present invention are to be included in the scope of the present invention.

I claim:

1. An AC to AC modified sine wave converter, comprising:
an AC input module (1), a rectifier filter circuit (2), a BUCK step-down circuit (3), a modified sine wave inverter bridge circuit (4), an inverter bridge control circuit (5), an AC output module (6), and a USB charging control circuit (7),
wherein the modified sine wave inverter bridge circuit (4) comprises MOSFET M2, MOSFET M3, MOSFET M4, MOSFET M5, an input voltage monitoring module (41), an output current detection module (42), a first driving module (43) connecting MOSFET M2 to the inverter bridge control circuit (5), a second driving module (44) connecting MOSFET M3 to the inverter bridge control circuit (5), a third driving module (45) connecting MOSFET M4 to the inverter bridge control circuit (5), and a fourth driving module (46) connecting MOSFET M5 to the inverter bridge control circuit (5), and an AC power supply circuit (8) is provided between the inverter bridge control circuit (5) and the USB charging control circuit (7).

2. The AC to AC modified sine wave converter according to claim 1, wherein the first driving module (43) comprises resistors R10 and R11 connected in series between the gate (G) of MOSFET M2 and the H01 pin of the inverter bridge control circuit (5), a diode D2 connected in parallel with resistor R10, and a resistor R14 connecting the gate (G) and source(S) of MOSFET M2; the second driving module (44), the third driving module (45), and the fourth driving module (46) are all identical to the first driving module (43); furthermore, the source (S) of MOSFET M2 is connected to the drain (D) of MOSFET 4 and then to the N-OUT pin of the AC output module (6), while the source (S) of MOSFET M3 and the drain (D) of MOSFET M5 are connected and then to the L-OUT pin of the AC output module (6).

3. The AC to AC modified sine wave converter according to claim 1, wherein the input voltage monitoring module (41) comprises resistors R1, R4, and R5 connected in series between the VBUS pin of the inverter bridge control circuit (5) and the BUCK step-down circuit (3), a capacitor C8 connected between the VBUS pin of the inverter bridge control circuit (5) and resistor R1 and then to the GND terminal, a capacitor C9 and resistor R16 connected between resistor R1 and resistor R4 and then to the GND terminal, and a capacitor C46 connected between resistor R1 and the modified sine wave inverter bridge circuit (4) and then to the GND terminal; the output current detection module (42) comprises resistors R31, R32, and R33 in parallel between the source(S) of MOSFET M4 and the source(S) of MOSFET M5.

4. The AC to AC modified sine wave converter according to claim 1, wherein the AC power supply circuit (8) comprises MOSFET M8 and a chip U9 connected in series between the USB charging control circuit (7) and the inverter bridge control circuit (5), capacitors C39 and C40 respectively connected to the IN and OUT pins of chip U9, and capacitors C41 and C42 connected to the drain (D) and source (S) of MOSFET M8, wherein the drain (D) of MOSFET M8 is connected to the VCC pin of the USB charging control circuit (7), the gate (G) of MOSFET M8 is grounded together with capacitors C41 and C42, the source(S) of MOSFET M8 and the IN pin of chip U9 connect to the +12V pin, and the GND pin of chip U9 and capacitors C39 and C40 are grounded.

5. The AC to AC modified sine wave converter according to claim 1, wherein the USB charging control circuit (7) comprises a fuse F3, a main control chip U6, a transformer T1, a power controller U3, a step-down converter U4, a first USB unit (71), a second USB unit (72), a third USB unit (73), and a fourth USB unit (74), wherein the fuse F3 is connected to the BUCK step-down circuit (3), the AC power supply circuit (8) is connected to the VCC pin of the power controller U3, and the first USB unit (71) and the second USB unit (72) are both TYPE-C output interfaces.

6. The AC to AC modified sine wave converter according to claim 1, wherein the inverter bridge control circuit (5) comprises a chip IC1, an output temperature detection module (51), and a fan control module (52), wherein the input voltage monitoring module (41) is connected to the VBUS and GND pins of chip IC1, and the first driving module (43), the second driving module (44), the third driving module (45), and the fourth driving module (46) are respectively connected to the H01, H02, LO1, and LO2 pins of chip IC1.

7. The AC to AC modified sine wave converter according to claim 6, wherein the output temperature detection module (51) comprises a capacitor C19, a resistor R35, a resistor R38, a resistor R78, and a diode LED1, wherein capacitor C19 and resistor R35, together with one end of resistor R38, are connected to the NTC pin of chip IC1, the other end of resistor R35 is connected to the AC-5V pin, the resistor R78 and diode LED1 are connected in series to the LED pin of chip IC1, and capacitor C19, resistor R38, and the other end of diode LED1 are grounded.

8. The AC to AC modified sine wave converter according to claim 6, wherein the fan control module (52) comprises a resistor R44, a resistor R46, an optocoupler P1, a resistor R47, a resistor R48, a MOSFET M7, and a fan F2, wherein resistor R44 and resistor R46 are connected in series to the FAN pin of chip IC1, one end of resistor R46 is grounded, and an optocoupler PAB is connected in parallel to resistor R46; the drain (D) of the MOSFET and optocoupler P1A are respectively connected to both terminals of the fan F2, resistor R47 is connected between the gate (G) of the MOSFET and optocoupler P1A, resistor R48 is connected between the gate (G) of MOSFET M7 and ground, and the source(S) of MOSFET M7 is grounded.

9. The AC to AC modified sine wave converter according to claim 1, wherein the BUCK step-down circuit (3) comprises MOSFET M1, a fifth driving module (31), a current detection module (32), an energy storage filter module (33), a power control module (34), a power supply module (35), a freewheeling module (36), and an output voltage detection module (37), wherein MOSFET M1 is connected to the rectifier filter circuit (2), the energy storage filter module (33) is connected to the modified sine wave inverter bridge circuit (4), and an optocoupler P3 is arranged between the power control module (34) and the output voltage detection module (37).

10. The AC to AC modified sine wave converter according to claim 9, wherein the current detection module (32) comprises resistors R34, R36, and R45 connected in parallel to the source (S) of MOSFET M1, wherein the other ends of resistors R34 and R36 are connected to the freewheeling module (36) and the energy storage filter module (33), and the other end of resistor R45 is connected to the power control module (34).
